(19) United States
(12) Patent Application Publication
(10) Pub. No.: US 2026/0242195 A1
(43) Pub. Date: Aug. 20, 2026

(54) ADJUSTABLE FORKLIFT MOUNTING KIT

(71) Applicant: Hyundai Translead, San Diego, CA (US)

(72) Inventors: Jimmy Minh Nguyen, San Diego, CA (US); Weilun Chang, San Diego, CA (US)

(21) Appl. No.: 19/456,354

(22) Filed: Jan. 22, 2026

Related U.S. Application Data
(60) Provisional application No. 63/758,828, filed on Feb. 14, 2025.

(51) Int. Cl. B66F 9/075

(52) U.S. Cl. CPC B66F 9/07563

(57) ABSTRACT

Adjustable forklift mounting systems, methods, devices, and kits are provided. The forklift mount can be advantageously adjusted to allow forklifts of many different makes, models, and manufacturers. The forklift mount can be mounted to a platform, such as a flatbed trailer. In one aspect, the adjustable forklift mount includes a tire rest configured to be reversibly received into and removed from a tube attached to a flatbed trailer, the tire rest held in place relative to the tube by a locking pin, the tire rest configured to be removed from the tube when the locking pin is removed, and a wheel stop slidably attached to a crossbar attached to a flatbed, the wheel stop held in place relative to the crossbar by a second locking pin.

### INCORPORATION BY REFERENCE TO ANY PRIORITY APPLICATIONS

This application claims the benefit of priority to U.S. Provisional Patent Application No. 63/758,828, entitled “ADJUSTABLE FORKLIFT MOUNTING KIT,” filed on Feb. 14, 2025, which is hereby incorporated by reference in its entirety and for all purposes.

### BACKGROUND

### Field

The present technology relates to an adjustable forklift mounting kit and methods of using an adjustable forklift mounting kit.

### Description of the Related Art

Forklift mounts are often mounted to flatbed trailers so that a forklift can be transported with the items placed on the trailer to load and unload the items. These forklift mounts can be limited in the makes and models of forklifts that can be transported with the flatbed trailer. Therefore, a need exists for a forklift mounting system which can accommodate forklifts of many different makes, models, and manufacturers.

### SUMMARY

For purposes of summarizing the present disclosure and its advantages, certain objects and advantages of the present disclosure are described herein. Not all such objects or advantages may be achieved in any particular embodiment of the present disclosure. Thus, for example, those skilled in the art will recognize that the present disclosure may be embodied or carried out in a manner that achieves or optimizes one advantage or group of advantages as taught herein without necessarily achieving other objects or advantages as may be taught or suggested herein.

In one aspect, a kit for mounting a forklift to a trailer is provided. The kit includes a wheel stop configured to adjust between a first configuration for mounting a first forklift of a first make and a second configuration for mounting a second forklift of a second, different make. The wheel stop including a hat bracket comprising an opening having a longitudinal axis, a sliding rail configured to translate along the longitudinal axis of the opening between a first position relative to the hat bracket and a second, different position relative to the hat bracket, a tire contact plate attached to a first end of the sliding rail, the tire contact plate configured to contact a tire of a first diameter of the first forklift when the sliding rail is in the first position and the first forklift is mounted to the trailer, the tire contact plate configured to contact a tire of a second, different diameter of the second forklift when the sliding rail is in the second position and the second forklift is mounted to the trailer, and a locking pin configured to secure the sliding rail in the first position and the second position relative to the hat bracket. The system includes a tire rest configured to be reversibly received in a tire rest tube and to contact the first tire when the first forklift is mounted to the trailer, the tire rest further configured to be removed from the tire rest tube when the second forklift is mounted to the trailer.

In some embodiments, the sliding rail further comprises a plurality of through holes, the locking pin configured to pass through the hat bracket and one of the plurality of through holes.

In some embodiments, the sliding rail further comprises a stopper plate attached to a second end of the sliding rail opposite the first end, the stopper plate configured to limit a rearward translation of the sliding rail relative to the hat bracket.

In some embodiments, the kit further includes a wheel stop mount configured to attach to a pair of main beams of the trailer, the hat bracket attached to a crossbar of the wheel stop mount.

In some embodiments, the kit further includes a tire rest mount configured to attach to the pair of main beams of the trailer.

In some embodiments, the kit further includes a first mud flap hanger positioned on a forward side of the crossbar of the wheel stop mount.

In some embodiments, the sliding rail is configured to translate within the opening of the hat bracket between the first position and the second position while maintaining the sliding rail within the opening of the hat bracket.

In one aspect, an adjustable forklift mount is provided. The adjustable forklift mount includes a tire rest configured to be reversibly received into and removed from a tube attached to a flatbed trailer, the tire rest held in place relative to the tube by a locking pin, the tire rest configured to be removed from the tube when the locking pin is removed, and a wheel stop slidably attached to a crossbar attached to a flatbed, the wheel stop held in place relative to the crossbar by a second locking pin.

In some embodiments, the adjustable forklift mount further includes a rear hook mount and a chain mount configured to secure a forklift to the flatbed trailer.

In some embodiments, the adjustable forklift mount further includes a plurality of folding bumper arms configured to fold inward to provide clearance for a forklift mounted to the flatbed trailer.

In some embodiments, the wheel stop includes a bracket, a sliding rail configured to translate within an opening of the bracket to a plurality of positions, a tire contact plate attached to an end of the sliding rail, the tire contact plate positioned forward of the tire rest, and a stopper plate configured to limit a rearward translation of the sliding rail relative to the bracket.

In some embodiments, the tire contact plate includes a curved surface, and where a concave surface of the curved surface faces away from the sliding rail.

In some embodiments, at least one of the first resilient isolator pad and the second resilient isolator pad include neoprene.

In some embodiments, the adjustable forklift mount further comprises a mud flap hanger forward of the tire contact plate.

In some embodiments, the wheel stop is attached to a top side of the crossbar.

In one aspect, an adjustable wheel stop is provided. The adjustable wheel stop includes a bracket, a sliding rail configured to translate along a longitudinal axis of the bracket, a tire contact plate attached to an end of the sliding rail, and a locking pin configured to fix the sliding rail in place relative to the bracket.

In some embodiments, the sliding rail comprises a plurality of through holes and the bracket comprises a through hole.

In some embodiments, the locking pin is configured to pass through one of the plurality of through holes and the through hole of the bracket to fix the sliding rail in place relative to the bracket.

In some embodiments, the one of the plurality of through holes and the through hole of the bracket are oriented such that the locking pin extends horizontally through the bracket and the sliding rail.

In some embodiments, the locking pin is configured to be removed from or engaged with the sliding rail and the bracket without tools.

In some embodiments, the adjustable wheel stop further includes, a stopper plate configured to limit a rearward translation of the sliding rail relative to the bracket

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates an embodiment of a forklift mount holding a forklift on a flatbed trailer.

FIG. 2 illustrates a perspective view a forklift mount according to an embodiment of the present disclosure.

FIG. 3 illustrates a perspective view of the forklift mount of FIG. 2.

FIG. 4A illustrates a perspective view of a tire rest mount and wheel stop mount attached to a flatbed trailer according to an embodiment of the present disclosure.

FIG. 4B illustrates a perspective view of a detailed portion of a wheel stop mount attached to a flatbed trailer according to an embodiment of the wheel stop mount attached to a flatbed trailer of FIG. 4A.

FIG. 4C illustrates a perspective view of a detailed portion of a wheel stop mount attached to a flatbed trailer according to an embodiment of the wheel stop mount attached to a flatbed trailer of FIG. 4A.

FIG. 5 illustrates a perspective view of an embodiment of the wheel stop of the forklift mount of FIGS. 2 and 3.

FIG. 6 illustrates a perspective view of an embodiment of the tire rest of the forklift mount of FIGS. 2 and 3.

### DETAILED DESCRIPTION

Systems, methods, devices, and kits for mounting a forklift according to the present disclosure can be advantageously adjusted to allow forklifts of many different makes, models, and manufacturers to be mounted to a platform, such as a flatbed trailer. Forklift mounting systems, methods, devices, and kits according to the present disclosure can be implemented on a variety of platforms, such as vehicles or structures connected to vehicles. For example, embodiments of forklift mounts described herein can be installed on a flatbed vehicle, such as but not limited to a flatbed trailer and a straight truck. Embodiments of forklift mounts according to the present disclosure can advantageously be compact, robust, and adjustable to accommodate a variety of forklift designs. For example, a forklift mount according to the present disclosure can be adjusted to a first configuration configured to receive a first type of forklift and then adjusted to a second configuration configured to receive a second, different type of forklift. Embodiments of forklift mounts according to the present disclosure can be advantageously retrofitted or installed on the aft portion of a frame of a flatbed trailer. Devices, systems, and methods described herein can increase the variety of forklifts which can be mounted on a platform, such as a flatbed trailer. Advantageously, embodiments of the forklift mount and methods described herein can include an adjustable sliding wheel stop which can be locked into a variety of positions to accommodate forklifts with a variety of tire diameters. The sliding wheel stop can slide from a first position to a second position without disconnecting the sliding wheel stop from the forklift mount. The adjustable sliding wheel stop can advantageously be repositioned quickly, safely, and ergonomically because the sliding wheel stop is supported by the forklift mount throughout the adjustment of the sliding wheel stop. Advantageously, embodiments of the forklift mount and methods according to the present disclosure can also include a tire rest which can be disengaged and removed from the forklift mount to allow the forklift mount to accommodate forklifts which are incompatible with a tire rest.

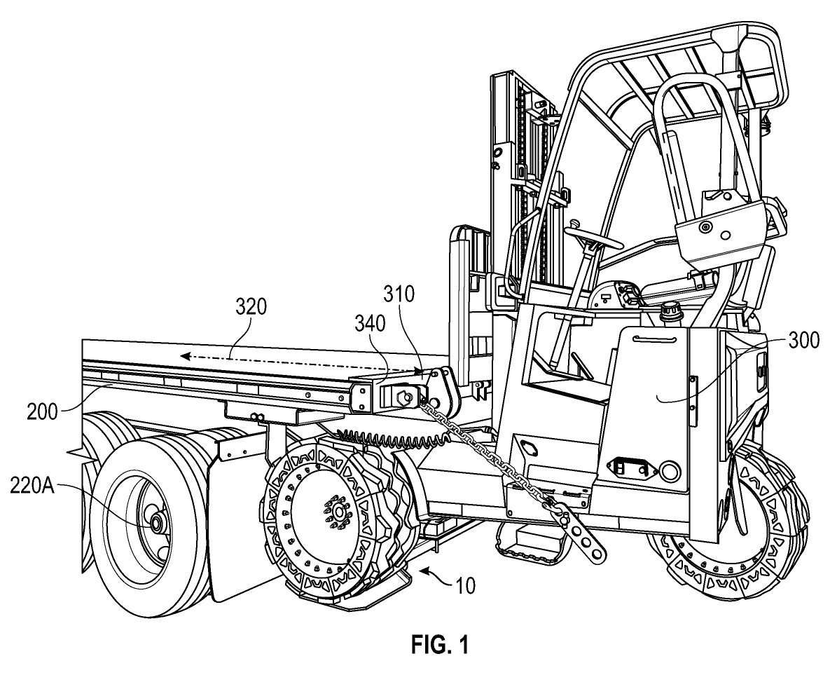

FIG. 1 illustrates a view of a forklift 300 attached to a flatbed trailer 200. The forklift 300 is attached to the flatbed trailer 200 using a forklift mount 10. The flatbed trailer 200 has a longitudinal axis 320 and includes a rear surface 340 and a pair of rear wheels 220A and 220B (the rear wheel 220B is not visible in FIG. 1). The rear surface 340 defines a plane 310 which is generally orthogonal to the longitudinal axis 320 of the flatbed trailer. The forklift mount 10 can allow a forklift to be secured to the flatbed trailer 200, for example to fastening mechanisms on the rear surface 340, without interfering with components of the flatbed trailer 200 (such as the rear wheels 220A, 220B and a rear bumper). The forklift 300 is attached to the flatbed trailer 200 using a forklift mount 10 that can accommodate a limited number of forklift types. For example, the forklift mount 10 cannot accommodate certain forklift types that are incompatible with a tire rest 150 of the forklift mount. For another example, the forklift mount 10 can only accommodate certain forklift types having wheels within a limited range of diameters. As a result, flatbed trailers 200 equipped with the forklift mount 10 can accommodate forklifts of a limited number of makes, models, and manufacturers. In addition, embodiments of the flatbed trailer 200 illustrated in FIG. 1 include a mud flap hanger 199 that is directly attached to a main beam 210. Embodiments of the mud flap hanger 199 can be susceptible to being bent forward or to towards the rear, causing the mud flap and/or the mud flap hanger 199 to contact and interfere with the wheel 220 of the flatbed trailer 200 or the wheel of the forklift 300.

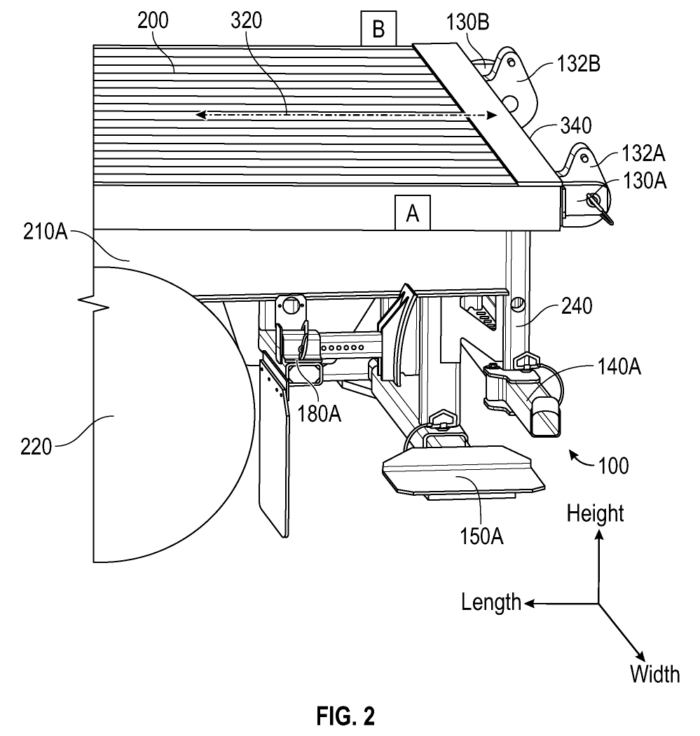

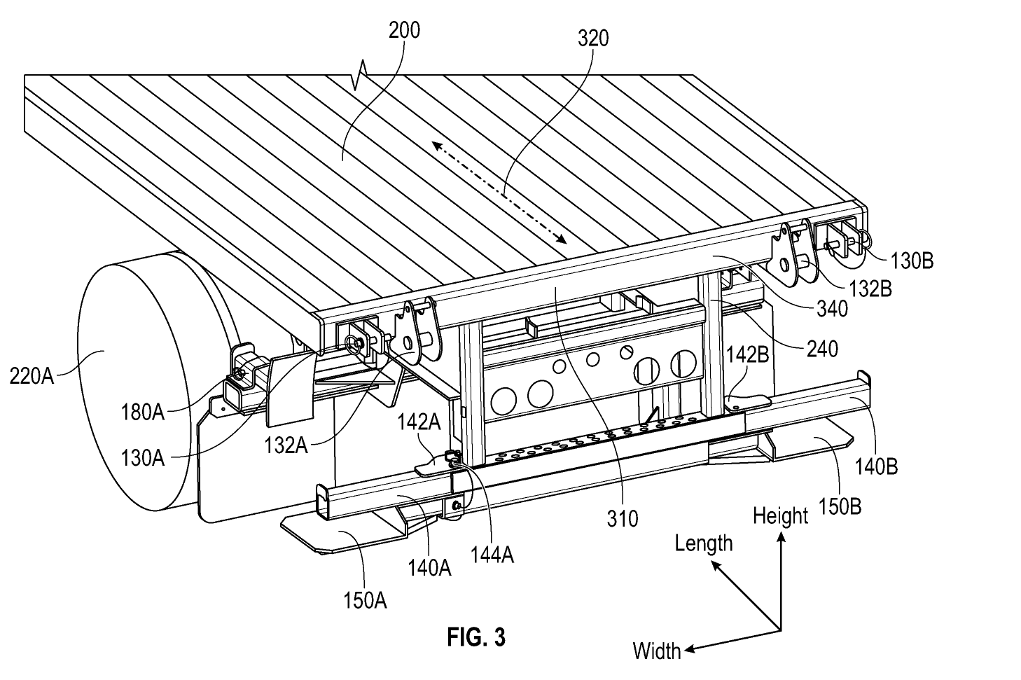

FIGS. 2 and 3 illustrate perspective views of a forklift mount 100 implemented on a flatbed trailer 200 according to an embodiment of the present disclosure. Advantageously, flatbed trailers 200 equipped with the forklift mount 100 according to embodiments of the present disclosure can accommodate significantly more makes, models, and manufacturers of forklifts than the forklift mount 10. For example, embodiments of the forklift mount 100 can accommodate as many as 30 or more different forklift models and makes from two or more different manufacturers, whereas embodiments of the forklift mount 10 can accommodate ten different forklift makes and models.

An “A” side of the forklift mount 100 is visible. A “B” side of the forklift mount 100 is only partially visible, however, it should be understood that the B side of the forklift mount 100 may include any or all of the features of the A side described herein mirrored over a centerline extending in the direction of the longitudinal axis 320 of the flatbed trailer 200, such that the B side components are positioned at substantially the same height, length, and width away from the center line as the A side components.

The forklift mount 100 can include a wheel stop 180A, a tire rest 150A, a folding bumper arm 140A, a chain mount 130A, and a hook mount 132A located on the A side of the centerline of the flatbed trailer 200 extending in the direction of the longitudinal axis 320. The wheel stop 180A and tire rest 150A can be positioned between the rear wheel 220 and the rear surface 340 of the flatbed trailer 200. The folding bumper arm 140A is attached to a bumper 240 of the flatbed trailer 200. The folding bumper arm 140Acan be positioned such that a rearward surface of the folding bumper arm 140A is substantially co-planar with the rear surface 340. The chain mount 130Aand the hook mount 132Aeach mount to the rear surface 340 of the flatbed trailer 200 and extend rearward from the rear surface 340.

The forklift mount 110 can include a second wheel stop 180B, a second tire rest 150B, and a second folding bumper arm 140B (not illustrated in FIG. 2). The forklift mount can also include a second chain mount 130B and a second hook mount 132B. The second wheel stop 180B, second tire rest 150B, second folding bumper arm 140B, second chain mount 130B, and second hook mount 132B can be located on the B side of the centerline of the flatbed trailer 200. The second wheel stop 180B and second tire rest 150B can be positioned between the rear wheel 220 and the rear surface 340 of the flatbed trailer 200. The folding bumper arm 140B is attached to a bumper 240 of the flatbed trailer 200. The folding bumper arm 140B can be positioned such that a rearward surface of the folding bumper arm 140B is substantially co-planar with the rear surface 340. The chain mount 130B and the hook mount 132B each mount to the rear surface 340 of the flatbed trailer 200 and extend rearward from the rear surface 340.

The wheel stops 180A and 180B are each spaced a width away from the centerline of the flatbed trailer 200 so that a forklift 300 can be positioned with a first front wheel contacting the wheel stop 180A and a second front wheel contacting the wheel stop 180B. The forklift 300 can be substantially centered relative to the centerline. The wheel stops 180A and 180B can be adjusted to accommodate a variety of forklift wheel diameters. The wheel stops 180A and 180B can be slid forward along the longitudinal axis 320 to accommodate a larger forklift wheel diameter. The wheel stops 180A and 180B can be slid rearward along the longitudinal axis 320 to accommodate a smaller wheel diameter. The wheel stops 180A, 180B can be configured to adjust between a first configuration for mounting a first forklift of a first make and a second configuration for mounting a second forklift of a second, different make. The wheel stops 180A and 180B can be adjustable to accommodate wheels having diameters in the range of 20 inches and 33 inches. In some examples, the wheel stops 180A and 180B can be adjustable to accommodate wheels having diameters of about 20, 21, 22, 23, 24, 25, 26, 27, 28, 29, 30, 31, 32, or 33 inches. In one non-limiting example of the present disclosure, the wheel stops 180A and 180B are adjustable to accommodate wheels having diameters in the range of 26 to 31 inches. Wheels of other diameters can be suitably implemented in embodiments of the present disclosure. Accordingly, embodiments of the forklift mount 100 according to the present disclosure can accommodate a significant number of forklift makes, models, and manufacturers spanning a large number of different wheel diameters.

The tire rest 150A can be positioned below and rearward of the wheel stop 180A. The tire rest 150B can be positioned below and rearward of the wheel stop 180B. Each tire rest 150A, 150B can be positioned such that when the wheel of a forklift 300 is pressed against a wheel stop 180A, 180B, the wheel of the forklift 300 can rest on top of the tire rest 150A, 150B. The tire rests 150A and 150B are removably attached to the flatbed trailer 200.

The folding bumper arms 140A and 140B can be positioned in an extended positioned where each folding bumper arm 140A, 140B is parallel to the plane 310. In the extended position, each folding bumper arm 140A and 140B extends in the width direction away from the centerline. The folding bumper arms 140A and 140B can be positioned in a folded position where each folding bumper arms 140A, 140B is perpendicular to the plane 310. In the folded position, the folding bumper arms 140A and 140B extend forward from the plane 310. In the folded position, the folding bumper arm 140A can be positioned inward from the wheel stop 180A and the tire rest 150A. In the folded position, the folding bumper arm 140B can be positioned inward from the wheel stop 180B and the second tire rest 150B. Advantageously, the folding bumper arms 140A and 140B can be transitioned between a first configuration and a second configuration. In the first configuration according to an example embodiment, the bumper, for example an ICC bumper, is arranged with the folding bumper arms 140A and 140B extended when a forklift is not secured to the flatbed trailer. The folding bumper arms 140A and 140B can be transitioned to a second configuration according to an example embodiment, in which the bumper is arranged with the folding bumper arms 140A and 140B in a folded configuration when a forklift is secured to the flatbed trailer. The second configuration can provide clearance for the wheels of the forklift.

The folding bumper arms 140A and 140B can be locked in the extended position or the folded position. The folding bumper arms 140A and 140B can each attach to a side of the bumper 240. The folding bumper arms 140A and 140B can each attach to a side of a bumper 240 with a hinge 142A and 142B respectively. The folding bumper arms 140A, 140B can pivot on the hinges 142A, 142B to transition from the extended position to the folded position. A locking pin 144A, 144B can reversibly fix the folding bumper arms 140A and 140B in either the extended position or the folded position. Advantageously, the folding bumper arms 140A and 140B can allow the flatbed trailer 200 compatible with many different types of forklifts 300 while maintaining an industry standard bumper. Additionally, the folding bumper arms 140A and 140B can allow the flatbed trailer 200 to utilize a maximum width bumper when the flatbed trailer 200 is not in use.

Different types of forklifts can be secured to a flatbed trailer 200 requiring different mounting arrangements for the forklifts. Advantageously, the forklift mounts described herein are compatible with many different types of forklifts.

In one non-limiting example, a forklift 300A can be held in place relative to the flatbed trailer 200. The forklift 300A is secured to the flatbed trailer 200 using the wheel stops 180A, 180B, the tire rests 150A, 150B, and the chain mounts 130A, 130B. The wheel stops 180A, 180B and the tire rests 150A, 150B engage with the front wheels of the forklift 300A and the chain mounts 130A, 130B support the body of the forklift 300A. The first wheel of the forklift 300 is engaged with the wheel stop 180A and sits on top of the tire rest 150A. A second wheel of the forklift 300 is engaged with the wheel stop 180B and sits on top of the tire rest 150B. The chain mounts 130A and 130B can attach to chains coupled to a forklift 300A to secure the forklift 300A in place relative to the flatbed trailer 200.

In another non-limiting example, a forklift 300B can be held in place relative to the flatbed trailer 200. The forklift 300B is secured to the flatbed trailer 200 using the wheel stops 180A, 180B, the hook mounts 132A, 132B, and the chain mounts 130A, 130B. The wheel stops 180A, 180B engage with the front wheels of the forklift 300B. The hook mounts 132A, 132B engage with hooks on the forklift 300B so that the hook mounts 132A and 132B support the vertical load of the forklift 300B. The first wheel of the forklift 300B can engaged with the wheel stop 180A and a second wheel of the forklift 300B can engaged with the wheel stop 180B so that the forklift 300B cannot rotate forward on the hook mounts 132A and 132B. The chain mounts 130A and 130B can attach to chains coupled to the forklift 300B to secure the forklift 300B relative to the flatbed trailer 200. The tire rests 150A and 150B can be removed from the forklift mount 100 to provide clearance for the forklift 300B which engages with the wheel stops 180A and 180B and would interfere with the tire rests. Such forklifts 300B do not require tire rests to mount the forklifts 300B onto a flatbed trailer 200, and cannot mount on a flatbed trailer 200 that includes tire rests because the tire rests would interfere with the forklift 300B while mounting the forklift 300B.

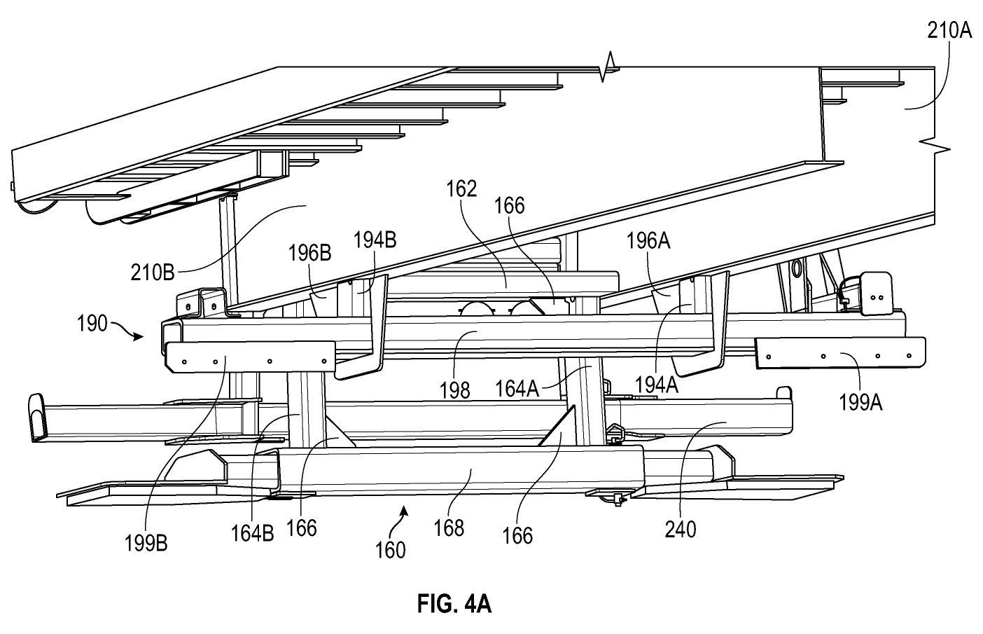

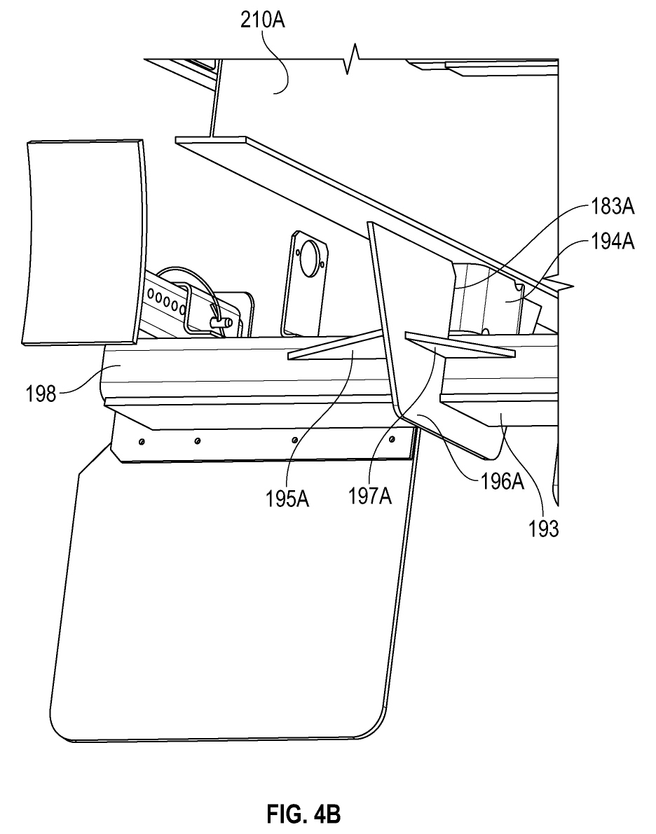

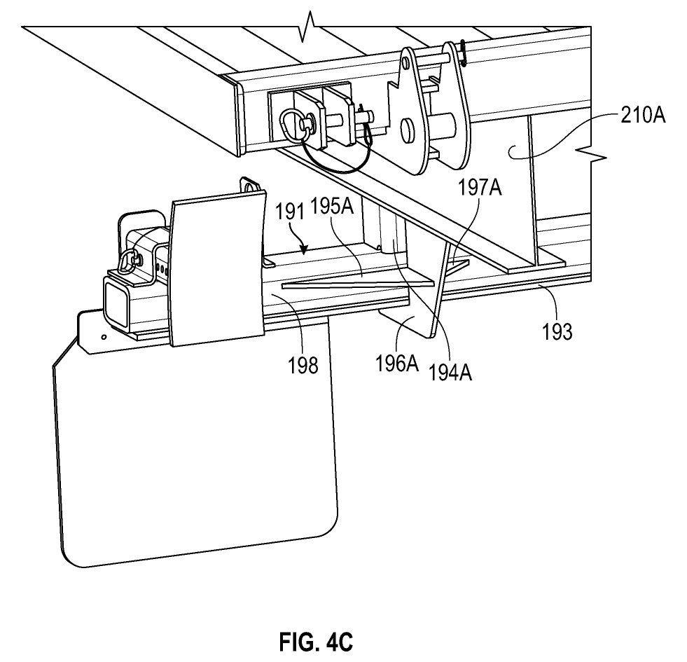

FIG. 4A illustrates the underside of the flatbed trailer 200 illustrating a wheel stop mount 190 and a tire rest mount 160 of the forklift mount 100 according to an embodiment of the present disclosure. The wheel stop mount 190 connects wheel stops 180A and 180B to the flatbed trailer 200. The tire rest mount 160 connects the tire rests 150A and 150B to the flatbed trailer 200. The wheel stop mount 190 can be a component of a kit that includes the pair of wheel stops 180A and 180B. The tire rest mount 160 can be a component of a kit that includes the pair of tire rests 150A and 150B. The tire rest mount 160 can be positioned rearward of the wheel stop mount 190. The tire rest mount 160 can be positioned forward of the bumper 240.

The flatbed trailer 200 can include a first main beam 210A and a second main beam 210B. The main beam 210Aand the main beam 210B can run lengthwise along the flatbed trailer 200 and parallel to the longitudinal axis 320. The main beam 210A can be an I-beam. The main beam 210B can be an I-beam. The main beam 210A can be spaced a distance away from the centerline of the flatbed trailer 200 on the A side of the flatbed trailer 200 and the main beam 210B can be spaced the same distance from the centerline on the B side of the flatbed trailer 200.

FIGS. 4B and 4C illustrate detailed views of a portion of the wheel stop mount 190. The wheel stop mount 190 can structurally support the wheel stops 180A and 180B. The wheel stop mount 190 can be made from galvanized steel, stainless steel, steel, or aluminum. In some examples, the wheel stop mount 190 can be welded to a flatbed trailer 200. In some examples, the wheel stop mount 190 and the wheel stops 180A, 180B can be installed on a flatbed trailer 200 as an aftermarket product, an accessory, or a trailer body kit. A flatbed trailer 200 can be retrofitted to include the wheel stop mount 190 and the wheel stops 180A, 180B. The wheel stops 180A and 180B can each include a mud flap hanger 199A and 199B respectively. The wheel stop mount 190 can include a crossbar 198, a first spacer 194A, a first gusset 196A, a second spacer 194B, and a second gusset 196B. The wheel stop mount 190 can also include a first outer lateral gusset 195A, a first inner lateral gusset 197A, a second outer lateral gusset 195B, a second inner lateral gusset 197B, and a crossbar support 193. Other materials can be suitably implemented in accordance with embodiments of the present disclosure.

The crossbar 198 can attach to the flatbed trailer 200. The crossbar 198 can span across all, substantially all, or a portion of the width of the flatbed trailer 200. The first spacer 194A can attach to the first main beam 210A and the second spacer 194B can attach to the second main beam 210B. The spacers can be welded to the main beams, for example. The crossbar 198 can attach to the first spacer 194A and the second spacer 194B. The crossbar 198 can be welded to the spacers, for example. The first spacer 194A can be positioned between the underside of the first main beam 210A and a top surface 191 of the crossbar 198. The second spacer 194B can be positioned between the underside of the second main beam 210B and the top surface 191 of the crossbar 198. The first spacer 194A and the second spacer 194B can space the crossbar 198 a distance away from the first main beam 210A and the second main beam 210B. In some examples, the distance between the crossbar 198 and the main beams 210A, 210B can be between 3 and 6 inches. For example, the distance can be, or be about, 3, 3.25, 3.5, 3.75, 4, 4.25, 4.5, 4.75, 5, 5.25, 5.5, 5.75, or 6 inches, or any value within a range defined by any two of the preceding values, though in some embodiments other distances may be implemented. In one non-limiting example, the distance between the crossbar 198 and the main beams 210A, 210B can be 4.5 inches.

The crossbar 198 and spacer 194A are received in a cut-out 183A in a gusset 196A. The gusset 196A can be configured to provide torsional support to the wheel stop mount 190. For example, the gusset 196A can be configured to resist torsional forces applied to the crossbar 198. In one example method of manufacture according to an embodiment of the present disclosure, the crossbar 198 can be welded to the spacer 194A, the crossbar 198 and the spacer 194A can be received in the cut-out 183A of the gusset 196A, and the gusset 196A can be welded to the spacer 194A and the crossbar 198. The gusset 196A can be a trapezoidal-shaped gusset. In another non-limiting example (not illustrated), the gusset 196A can be a rectangular-shaped or square-shaped gusset. Other shapes can be suitably implemented.

The cross section of the crossbar 198 can be received in the cut-out 183A. For example, a portion of the crossbar 198 inward of the wheel stop 180A can pass through the cut-out 183A. A bottom surface of the crossbar 198 can contact a lower edge of the cut-out 183A. In some non-limiting examples, the bottom surface of the crossbar 198 is welded to the lower edge of the cut-out 183A. In some non-limiting examples, a crossbar support 193 is positioned against the bottom surface of the crossbar 198. The crossbar support 193 can be welded to the lower edge of the cut-out 183A and/or the bottom surface of the crossbar 198. The first spacer 194A can be received in the cut-out 183A. Two side surfaces of the first spacer 194A can contact side edges of the cut-out 183A. In some non-limiting examples, the side surfaces of the first spacer 194A are welded to the side edges of the cut-out 183A. In some examples, the gusset 196A can include a rearward triangular portion attached to the rear side of the first spacer 194A and the crossbar 198 and a forward triangular portion attached to a forward side of the first spacer 194A and the crossbar 198.

In some non-limiting examples, the wheel stop mount 190 can include a first outer lateral gusset 195A attached to the rear side of the crossbar 198 and the gusset 196A, and an inner lateral gusset 197A attached to the rear side of the crossbar 198 and the gusset 196A. The first outer lateral gusset 195A can be perpendicular to the gusset 196A. The first outer lateral gusset 195A and the first inner lateral gusset 197A can be positioned on opposite sides of the gusset 196A. The first outer lateral gusset 195A can be positioned on the side of the gusset 196A positioned away from the centerline and the first inner lateral gusset 197A can be positioned on the side of the gusset 196A positioned closer to the centerline. The first outer lateral gusset 195A can have a triangular shape. The first inner lateral gusset 197A can have a triangular shape.

The crossbar 198 and the spacer 194B are received in a cut-out 183B in a gusset 196B. The gusset 196B can be configured to provide torsional support to the wheel stop mount 190. For example, the gusset 196B can be configured to resist torsional forces applied to the crossbar 198. In one example method of manufacture according to an embodiment of the present disclosure, the crossbar 198 can be welded to the spacer 194B, the crossbar 198 and the spacer 194B can be received in the cut-out 183B of the gusset 196B, and the gusset 196B can be welded to the spacer 194B and the crossbar 198. The gusset 196B can be welded to the spacer 194B and crossbar 198. The gusset 196B can be a trapezoidal-shaped gusset. In another non-limiting example (not illustrated), the gusset 196B can be a rectangular-shaped or square-shaped gusset. Other shapes can be suitably implemented.

The cross section of the crossbar 198 can be received in the cut-out 183B. For example, a portion of the crossbar 198 inward of the wheel stop 180B can pass through the cut-out 183B. A bottom surface of the crossbar 198 can contact a lower edge of the cut-out 183B. In some non-limiting examples, the bottom surface of the crossbar 198 is welded to the lower edge of the cut-out 183B. In some non-limiting examples, the crossbar support 193 is positioned against the bottom surface of the crossbar 198. The crossbar support 193 can be welded to the lower edge of the cut-out 183B and/or the bottom surface of the crossbar 198. The second spacer 194B can be received in the cut-out 183B. Two side surfaces of the second spacer 194B can contact side edges of the cut-out 183B. In some non-limiting examples, the side surfaces of the second spacer 194B are welded to the side edges of the cut-out 183B. In some examples, the gusset 196B can include a rearward triangular portion attached to the rear side of the second spacer 194B and the crossbar 198 and a forward triangular portion attached to a forward side of the second spacer 194B and the crossbar 198.

In some non-limiting examples, the wheel stop mount 190 can include a second outer lateral gusset 195B (not pictured) attached to the rear side of the crossbar 198 and the gusset 196B and a second inner lateral gusset 197B (not pictured) attached to the rear side of the crossbar 198 and the gusset 196B. The second outer lateral gusset 195B can be perpendicular to the gusset 196B. The second outer lateral gusset 195B and the second inner lateral gusset 197B can be positioned on opposite sides of the gusset 196B. The second outer lateral gusset 195B can be positioned on the side of the gusset 196B positioned away from the centerline and the second inner lateral gusset 197B can be positioned on the side of the gusset 196B positioned closer to the centerline. The second outer lateral gusset 195B can have a triangular shape. The second inner lateral gusset 197B can have a triangular shape.

The crossbar 198 can extend widthwise on the A side past the first main beam 210A. The crossbar 198 can extend widthwise on the B side past the second main beam 210B. The first mud flap hanger 199A can attach to the crossbar 198 on the A side exterior to the first main beam 210A. The first mud flap hanger 199A can be positioned on a forward side of the crossbar 198. In some examples, the first mud flap hanger 199A is welded or bolted into the forward side of the crossbar 198. The first mud flap hanger 199A can be positioned to align widthwise with the rear wheel of the flatbed trailer 200. The first mud flap hanger 199A can be positioned a distance C from the main beam 210A. The distance C can be between 2 and 8 inches. For example, the distance C can be, or be about 2, 3, 4, 5, 6, 7, or 8 inches, or any value within a range defined by any two of the preceding values, though in some embodiments other distances may be implemented. In one non-limiting example, the distance C can be 5 inches.

The second mud flap hanger 199B can attach to the crossbar 198 on the B side exterior to the second main beam 210B. The second mud flap hanger 199B can be positioned on a forward side of the crossbar 198. In some examples, the first mud flap hanger 199B is welded or bolted into the forward side of the crossbar 198. The second mud flap hanger 199B can be positioned to align widthwise with the rear wheel of the flatbed trailer 200. The second mud flap hanger 199B can be positioned a distance C from the main beam 210B. The distance C can be between 2 and 8 inches. For example, the distance C can be, or be about 2, 3, 4, 5, 6, 7, or 8 inches, or any value within a range defined by any two of the preceding values, though in some embodiments other distances may be implemented. In one non-limiting example, the distance C can be 5 inches.

The mud flap hangers 199A, 199B can advantageously be positioned so that a mud flap attached to the mud flap hanger 199A, 199B does not interfere with wheel stops 180A, 180B. Additionally, the mud flap hanger 199A, 199B being positioned on the crossbar 198 can advantageously create a secure mounting position for a mud flap hanger. For example, the mud flap hangers 199A and 199B according to the present disclosure are less susceptible to bending, breaking, or being damaged when objects contact the mud flap hanger 199A and 199B.

The tire rest mount 160 can structurally support the tire rests 150A and 150B. The tire rest mount 160 can be formed from galvanized steel, stainless steel, steel, or aluminum. Other materials can be suitably implemented in accordance with embodiments of the present disclosure. In some examples, the tire rest mount 160 can be welded to a flatbed trailer 200. In some examples, the tire rest mount 160 and the tire rests 150A, 150B can be installed on a flatbed trailer 200 as an aftermarket product, an accessory, or a trailer body kit. A flatbed trailer 200 can be retrofitted to include the tire rest mount 160 and the tire rests 150A, 150B. The tire rest mount 160 can include a cross tube 162 positioned between the first main beam 210A and the second main beam 210B.

The cross tube 162 can be positioned above and contacting a bottom flange of the first main beam 210A and a bottom flange of the second main beam 210B. A first vertical tube 164A can attach to the cross tube 162. The first vertical tube 164A can extend downward from the cross tube 162. The first vertical tube 164A can be positioned on the A side of the flatbed trailer 200 interior to the to the first main beam 210A. A second vertical tube 164B can attach to the cross tube 162 and extend downward from the cross tube 162. The second vertical tube 164B can be positioned on the B side of the flatbed trailer 200. The second vertical tube 164B can be interior to the second main beam 210B. The first vertical tube 164A and the second vertical tube 164B can each be longer than the first spacer 194A and the second spacer 194B. A tube or tire rest tube 168 can attach to the flatbed trailer 200 at the bottom end of the first vertical tube 164A and the second vertical tube 164B. All or a portion of the tire rest tube 168 can be hollow. The tire rest tube 168 can be positioned below the crossbar 198. The tire rest tube 168 extends widthwise past the first vertical tube 164A and extends widthwise past the second vertical tube 164B. The cross tube 162, the first vertical tube 164A, the second vertical tube 164B, and tire rest tube 168 can form a substantially rectangular outline.

A gusset 166 can be positioned in each interior corner of a substantially rectangular frame formed from the cross tube 162, the first vertical tube 164A, the second vertical tube 164B, and the tire rest tube 168. While not all of the gussets 166 are visible in FIG. 4A, it will be understood that each gusset 166 interacts with the rectangular frame in substantially the same way. For example, a gusset 166 can be positioned between the cross tube 162 and the first vertical tube 164A. A gusset 166 can be positioned between the cross tube 162 and the second vertical tube 164B. A gusset 166 can be positioned between the tire rest tube 168 and the first vertical tube 164A. A gusset 166 can be positioned between the tire rest tube 168 and the second vertical tube 164B. Each of the gussets 166 can be triangular. The gussets 166 can be configured to increase the structural stability of the tire rest mount 160.

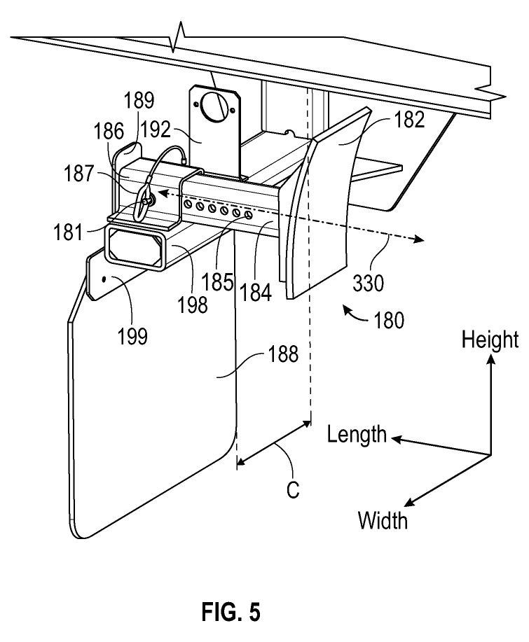

FIG. 5 illustrates a wheel stop 180 of the forklift mount 100 of FIGS. 2 and 3 according to an embodiment of the present disclosure. The wheel stop 180 can be attached at an end of a crossbar 198 on a top side of the crossbar 198. The wheel stop 180 can be slidably attached to the crossbar 198. The wheel stop 180 can be made from galvanized steel, stainless steel, steel, or aluminum. Other materials can be suitably implemented in accordance with embodiments of the present disclosure. The wheel stop 180 can be adjustable. For example, a position of a tire contact plate relative to the crossbar 198 can be adjusted. The position of the tire contact plate relative to the crossbar 198 can be advantageously adjusted to be compatible with a large number of forklifts 300 having different wheel diameters. The position of the tire contact plate relative to the crossbar 198 can be advantageously adjusted prior to securing a forklift 300 to the flatbed trailer 200. The wheel stop 180 includes a bracket 186, a sliding rail 184, a tire contact plate 182, a stopper plate 189, and a locking pin 187.

The sliding rail 184 can have a square or rectangular cross section. The length of the sliding rail 184 can be between 8 and 16 inches. For example, the length of the sliding rail 184 can be 8, 8.5, 9, 9.5, 10, 10.5, 11, 11.5, 12, 12.5, 13, 13.5, 14, 14.5, 15, 15.5, or 16 inches or more, or any value within a range defined by any two of the preceding values, though in some embodiments other lengths may be implemented. The tire contact plate 182 can be attached to a first end of the sliding rail 184. The tire contact plate 182 can be welded to the first end of the sliding rail 184. The tire contact plate 182 can include a curved surface. The curved surface of the tire contact plate 182 can be positioned such that the concave surface of the curve faces away from the sliding rail 184. A curvature of the surface of the tire contact plate 182 can be substantially the same as the curvature of a portion of a forklift wheel. The stopper plate 189 can be attached to a second end of the sliding rail 184.

The sliding rail 184 can include a plurality of through holes 185 extending through a side wall of the sliding rail 184. The through holes 185 can be positioned perpendicular to the length of the sliding rail 184. The sliding rail 184 can include 2, 3, 4, 5, 6, 7, 8, 9, 10, 11, 12 or more through holes 185. The through holes 185 can be spaced between 0.5 and 10 inches apart from one another. For example, the through holes 185 can be spaced apart 0.25, 0.5, 0.75, 1, 1.25, 1.5, 1.75, 2, 2.5, 3, 3.5, 4, 4.5, 5, 5.5, 6, 6.5, 7, 7.5, 8 8.5, 9, 9.5, or 10 inches or more, or any value within a range defined by any two of the preceding values, though in some embodiments other spacings may be implemented. In certain embodiments, the through holes are spaced 1 inch apart from one another.

In some examples, the bracket 186 can be a hat bracket. The bracket 186 can include a U-shaped bend between two flanges. The U-shaped bend defines an opening. The opening of the bracket 186 can have a longitudinal axis 330. Each flange can be attached to the crossbar 198. In some examples the flanges can be welded to the crossbar 198. The bracket 186 can be oriented so that the longitudinal axis 330 of the opening of the U-shaped bend is perpendicular to the crossbar 198. The longitudinal axis 330 of the opening of the U-shaped bend can be oriented to align with and/or be substantially parallel with the longitudinal axis 320 of the flatbed trailer 200. A through hole 181 can pass through the U-shaped bend of the bracket 186. In some examples, the bracket 186 can be a box rail bracket. It will be understood that embodiments of the present disclosure are not limited to the bracket 186 and other types of brackets can be suitably implemented.

The sliding rail 184 can engage with the bracket 186. The U-shaped bend can be configured to receive the sliding rail 184 through the opening. A portion of the sliding rail 184 can be positioned within the bracket 186. The sliding rail 184 can translate along the longitudinal axis of the opening of the U-shaped bend. The sliding rail 184 can be oriented such that the stopper plate 189 is forward of the bracket 186 and the tire contact plate 182 is rearward of the bracket 186. The sliding rail 184 can translate within the opening of the bracket 186 to a plurality of positions. The sliding rail 184 can translate along the longitudinal axis 330 of the opening of the bracket 186 between a first position relative to the bracket 186 and a second, different position relative to the bracket 186. The tire contact plate 182 can be configured to contact a tire of a first diameter when the sliding rail 184 is in the first position. The tire contact plate 182 can contact a tire of a second, different diameter when the sliding rail 184 is in the second position.

A locking pin 187 can secure the sliding rail 184 in position relative to the flatbed trailer 200. The locking pin 187 can secure the sliding rail 184 in position relative to the crossbar 198. The locking pin 187 can secure the sliding rail 184 in position relative to the bracket 186. The locking pin 187 can secure the sliding rail 184 in position relative to the U-shaped bend of the bracket 186. The through holes can be oriented such that the locking pin 187 extends horizontally through the bracket 186 and the sliding rail 184. The locking pin 187 can be positioned so that the locking pin 187 passes from the outer side (for example more external and away from the center side) of the bracket 186 to the inner side (for example the more interior and towards the center side) of the bracket 186. The horizontal orientation of the through holes can advantageously ensure that the locking pin 187 does not inadvertently disengage due to gravity. Additionally, the horizontal orientation of the through holes can advantageously make installing the locking pin ergonomically efficient. The locking pin 187 can extend through the through hole 181 of the bracket 186 and through one of the through holes 185 of the sliding rail 184. The locking pin 187 can be removed and the sliding rail 184 can be slid into a new position such that a different one of the through holes 185 aligns with the through hole 181 of the bracket 186. The locking pin 187 can then be repositioned in the through hole 181 to lock the sliding rail 184 in the new position. The locking pin 187 can be a hitch pin, a bolt and nut fastener, or a clevis and cotter pin. Other types of fasteners can be suitably implemented in embodiments of the present disclosure. In some examples, the locking pin 187 can advantageously be removed and/or engaged with the bracket 186 and the sliding rail 184 without the use of additional tools.

The stopper plate 189 can limit the rearward translation of the sliding rail 184 relative to the bracket 186. The tire contact plate 182 can limit the forward translation of the sliding rail 184 relative to the bracket 186. In some examples, to assemble the wheel stop mount 190, the tire contact plate 182 is welded to the sliding rail 184. The sliding rail 184 is slid into the opening of the U-shaped bend of the bracket 186. Once the sliding rail 184 is received in the bracket 186, the stopper plate 189 is attached to the sliding rail 184. The sliding rail 184 can include an internal plate at the second end. The stopper plate 189 can attach to the internal plate. The stopper plate 189 can be riveted to the internal plate. Advantageously, riveting the stopper plate 189 to the sliding rail 184 can allow both the stopper plate 189 and the sliding rail 184 to be galvanized prior to installing the wheel stop 180 on the wheel stop mount 190. In some examples, the stopper plate 189 can be welded to the sliding rail 184.

The wheel stop 180 can include a mud flap 188 which can attach to the mud flap hanger 199 forward of the tire contact plate 182. The mud flap 188 can attach to the mud flap hanger 199 with a nut and bolt connection. The mud flap hanger 199 can advantageously position the mud flap 188 so that the tire contact plate 182 and the sliding rail 184 do not interfere with the mud flap 188. The positioning of the mud flap 188 on the forward side of the crossbar 198 can advantageously protect the tire contact plate 182 and the sliding rail 184 from debris flying off the wheel. Additionally, the mud flap hanger 199 being positioned on the crossbar 198 can create a secure mounting position for the mud flap hanger 199. For example, embodiments of the mud flap hanger 199 according to the present disclosure are less susceptible to bending, breaking, or being damaged by objects coming into contact with the mud flap 188 or the mud flap hanger 199.

An electrical connection bracket 192 can be positioned interior to the bracket 186. Electrical connections between the flatbed trailer 200 and the taillights of a forklift 300 attached to the flatbed trailer 200 can be received through an opening in the electrical connection bracket 192 and/or mounted onto the electrical connection bracket 192. In one non-limiting example, a 7-way standard connector can be received through to the opening in the electrical connection bracket 192.

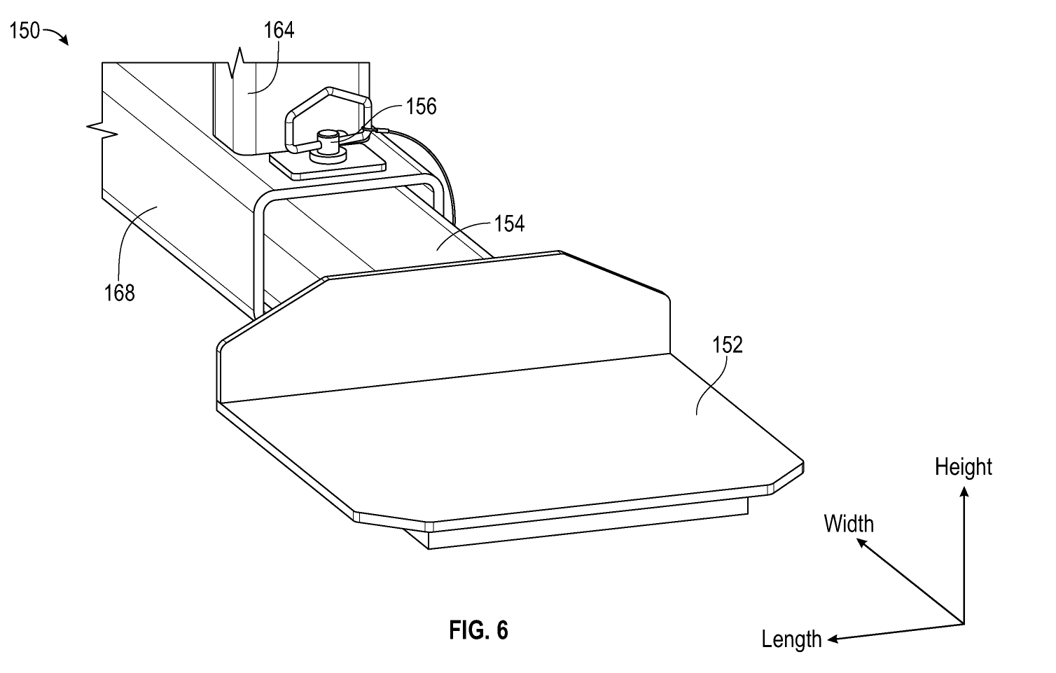

FIG. 6 illustrates a tire rest 150 of the forklift mount 100 of FIGS. 2 and 3 according to an embodiment of the present disclosure. The tire rest 150 can be attached to an end of a tire rest tube 168. The tire rest 150 can attach to the tire rest tube 168 exterior to a vertical tube 164. The tire rest 150 can be reversibly engaged or disengaged from the tire rest tube 168. In some examples, the tire rest tube 168 can reversibly receive or removed from the tire rest 150. The tire rest 150 can be made from galvanized steel, stainless steel, steel, or aluminum. Other materials can be suitably implemented in accordance with embodiments of the present disclosure. The tire rest 150 includes a tire rest plate 152 and an inner tube 154. The inner tube 154 can have a width which is substantially longer than the length and height of the inner tube 154. The tire rest plate 152 can be attached to a first end of the inner tube 154.

The tire rest 150 can be configured to be received in the tire rest tube 168. The inner tube 154 can slide into the tire rest tube 168. The tire rest plate 152 can be oriented such that when the inner tube 154 is received in the tire rest tube 168, the tire rest plate 152 is perpendicular to the plane 310. A locking pin 156 can fix the inner tube 154 in position relative to the tire rest tube 168. The locking pin 156 can pass through a through hole in the tire rest tube 168 and through a through hole in the inner tube 154. The inner tube 154 can extend a distance past the through hole so that a length of the inner tube 154 can be positioned interior to the tire rest tube 168. A substantial portion (for example approximately one half or greater than one half of the length) of the inner tube 154 can be positioned interior to the tire rest tube 168. The portion of the inner tube 154 received in the tire rest tube 168 can further support the inner tube 154 relative to the tire rest tube 168 and limit shear forces on the locking pin 156. Advantageously, in embodiments of the present disclosure, the substantial portion of the inner tube 154 positioned interior to the tire rest tube 168 can allow the tire rest 150 to support forklifts that can weigh for example between 3,000 and 10,000 lbs. To remove the tire rest 150 from the forklift mount 100, the locking pin 156 is disengaged and the inner tube 154 is slid out of the tire rest tube 168. The locking pin 156 can be a hitch pin, a bolt and nut fastener, or a clevis and cotter pin. Other types of fasteners can be suitably implemented in embodiments of the present disclosure. When a forklift that accommodates a tire rest is secured to the flatbed trailer 200, the inner tube 154 can be re-inserted into the tire rest tube 168. Advantageously the tire rest 150 can be reversibly received in and removed from the tire rest mount 160 without requiring any tools.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the present disclosure.

What is claimed is:

1. A kit for mounting a forklift to a trailer, the kit comprising:
a wheel stop configured to adjust between a first configuration for mounting a first forklift of a first make and a second configuration for mounting a second forklift of a second, different make, the wheel stop comprising:
a hat bracket comprising an opening having a longitudinal axis,
a sliding rail configured to translate along the longitudinal axis of the opening between a first position relative to the hat bracket and a second, different position relative to the hat bracket,
a tire contact plate attached to a first end of the sliding rail, the tire contact plate configured to contact a tire of a first diameter of the first forklift when the sliding rail is in the first position and the first forklift is mounted to the trailer, the tire contact plate configured to contact a tire of a second, different diameter of the second forklift when the sliding rail is in the second position and the second forklift is mounted to the trailer, and
a locking pin configured to secure the sliding rail in the first position and the second position relative to the hat bracket; and
a tire rest configured to be reversibly received in a tire rest tube and to contact the first tire when the first forklift is mounted to the trailer, the tire rest further configured to be removed from the tire rest tube when the second forklift is mounted to the trailer.

2. The kit of claim 1, wherein the sliding rail further comprises a plurality of through holes, the locking pin configured to pass through the hat bracket and one of the plurality of through holes.

3. The kit of claim 1, wherein the sliding rail further comprises a stopper plate attached to a second end of the sliding rail opposite the first end, the stopper plate configured to limit a rearward translation of the sliding rail relative to the hat bracket.

4. The kit of claim 1, further comprising a wheel stop mount configured to attach to a pair of main beams of the trailer, the hat bracket attached to a crossbar of the wheel stop mount.

5. The kit of claim 4, further comprising a tire rest mount configured to attach to the pair of main beams of the trailer.

6. The kit of claim 5, further comprising a first mud flap hanger positioned on a forward side of the crossbar of the wheel stop mount.

7. The kit of claim 1, wherein the sliding rail is configured to translate within the opening of the hat bracket between the first position and the second position while maintaining the sliding rail within the opening of the hat bracket.

8. An adjustable forklift mount, comprising:
a tire rest configured to be reversibly received into and removed from a tube attached to a flatbed trailer, the tire rest held in place relative to the tube by a locking pin, the tire rest configured to be removed from the tube when the locking pin is removed; and
a wheel stop slidably attached to a crossbar attached to a flatbed, the wheel stop held in place relative to the crossbar by a second locking pin.

9. The adjustable forklift mount of claim 8, further comprising a rear hook mount and a chain mount configured to secure a forklift to the flatbed trailer.

10. The adjustable forklift mount of claim 8, further comprising a plurality of folding bumper arms configured to fold inward to provide clearance for a forklift mounted to the flatbed trailer.

11. The adjustable forklift mount of claim 8, wherein the wheel stop comprises:
a bracket;
a sliding rail configured to translate within an opening of the bracket to a plurality of positions;
a tire contact plate attached to an end of the sliding rail, the tire contact plate positioned forward of the tire rest; and
a stopper plate configured to limit a rearward translation of the sliding rail relative to the bracket.

12. The adjustable forklift mount of claim 11, wherein the tire contact plate comprises a curved surface, and wherein a concave surface of the curved surface faces away from the sliding rail.

13. The adjustable forklift mount of claim 11, further comprising a mud flap hanger forward of the tire contact plate.

14. The adjustable forklift mount of claim 11, wherein the wheel stop is attached to a top side of the crossbar.

15. An adjustable wheel stop comprising:
a bracket;
a sliding rail configured to translate along a longitudinal axis of the bracket;
a tire contact plate attached to an end of the sliding rail; and
a locking pin configured to fix the sliding rail in place relative to the bracket.

16. The adjustable wheel stop of claim 15, wherein the sliding rail comprises a plurality of through holes and the bracket comprises a through hole.

17. The adjustable wheel stop of claim 16, wherein the locking pin is configured to pass through one of the plurality of through holes and the through hole of the bracket to fix the sliding rail in place relative to the bracket.

18. The adjustable wheel stop of claim 17, wherein the one of the plurality of through holes and the through hole of the bracket are oriented such that the locking pin extends horizontally through the bracket and the sliding rail.

19. The adjustable wheel stop of claim 15, wherein the locking pin is configured to be removed from or engaged with the sliding rail and the bracket without tools.

20. The adjustable wheel stop of claim 15, further comprising a stopper plate configured to limit a rearward translation of the sliding rail relative to the bracket.
